(19) United States
(12) Patent Application Publication
(10) Pub. No.: US 2003/0220937 A1
(43) Pub. Date: Nov. 27, 2003

(54) Portable computer with a schedule management function

(76) Inventors: Jun Maeoka, Kawasaki (JP); Atsushi Ogino, Kodaira (JP); Masahiko Saito, Mito (JP); Hiroshi Shimizu, Yokohama (JP); Shinichi Obata, Fujisawa (JP); Nobuaki Kohinata, Yokohama (JP)

Correspondence Address: MCDERMOTT WILL & EMERY, 600 13TH STREET, N.W., WASHINGTON, DC, 20005-3096, US

(21) Appl. No.: 10/227,551

(22) Filed: Aug. 26, 2002

(30) Foreign Application Priority Data
May 27, 2002 (JP) 2002-151719

(51) Int. Cl. G06F 7/00

(52) U.S. Cl. 707/104.1

(57) ABSTRACT

To solve the problem of existing terminals having a memorandum function in that the terminals cannot share a memorandum, or are not suitable for assisting execution of a matter by a plurality of users, a memorandum terminal has a function of assisting a plurality of memorandum terminals to share a memorandum and to also share a completion state of the memorandum. The memorandum terminal further has a function of changing a display sequence of the memorandum of its own in accordance with the condition of other users, and assists execution of a memorandum having higher priority.

### BACKGROUND OF THE INVENTION

Some of existing mobile information terminals have a memorandum faction that stores the contents of actions to be executed in future by users of the mobile information terminals as a document with the terms and priority of the actions and enables the users to look up the document, whenever necessary. The memorandum function sometimes includes a function of displaying a list of the memorandums in the sequence of terms and priority on the basis of the terms and priority designated and inputted by the users at the time of registration of the memorandum, and a function of raising an alarm and notifying the users of the term when the term draws near. Still another function of the memorandum function is to erase a corresponding memorandum when a completion input is made after the execution of a matter of the memorandum content, and its display sequence is put to a trailing position when the list of the memorandums is displayed. The memorandum function is a function that assists storage of the matters to be executed and check of execution and completion of the matters in accordance with priority.

This memorandum function is described, for example, in JP-A-8-129516. This reference describes a memorandum terminal that transmits a certain request matter from a terminal of a party requesting the matter to a terminal of a requested party, automatically registers the request matter to the information terminal of requested party and notifies the requesting party of a completion report of the requested party.

The memorandum function according to the prior art technology described above can assist the matter that is executed by one member of a group, but is not suitable for assisting the matter that are executed by a plurality of members. When the memorandum function assists the matter the execution of which is completed by any one of a certain group, for example, the memorandum having the same content must be registered to the terminals of all the members of the group. When any one of the group completes the matter of the memorandum, the other members cannot know this completion.

In the technology described in JP-A-8-129516, a plurality of members cannot share the memorandum and completion of the execution. In the technology of this reference, both requesting party and requested party are stationary, and the memorandum that may well be executed by anyone of the group cannot be accomplished.

In the prior art technology, a user must input priority. Updating of priority and the change of a display mode cannot be made in accordance with external factors of the memorandum terminal such as the conditions of other users, the location at which this memorandum terminal exists, the surrounding condition of the memorandum terminal, and so forth.

### SUMMARY OF THE INVENTION

It is an object of the invention to provide a memorandum-sharing terminal that enables a plurality of members to share a memorandum. In other words, the invention provides a memorandum terminal capable of sharing/managing a memorandum by a plurality of members by allowing all the members of a group to share preparation and registration of a new memorandum, completion of the memorandum, and so forth.

It is another object of the invention to provide a memorandum terminal for assisting execution of efficient memorandum management by a plurality of members by dynamically changing priority and display priority in accordance with conditions of other members and external factors, and making management easy.

A memorandum terminal according to the invention includes a memorandum data storage portion for storing a memorandum DB, an input device for inputting the memorandum data, an output device for displaying the memorandum data, a processing portion for processing the memorandum data and a transmitter/ receiver for exchanging the memorandum data with other memorandum terminals, wherein the processing portion transmits new memorandum data to other memorandum terminals through the transmitter/receiver and executes an updating process of the memorandum DB on the basis of the memorandum data received from other memorandum terminals through the transmitter/receiver. In this way, a plurality of memorandum terminals can easily share the memorandum DB. Management of the memorandum DB becomes easier when new memorandum data contains information of execution completion of the memorandum data. When the new memorandum data contains also priority change information, the priority change information can be easily transmitted to other memorandum terminals, and each memorandum terminal can change the display mode or the display sequence. The mode of display can be so controlled as to be appropriate for each terminal.

The memorandum terminal according to the invention changes priority of the memorandum data in accordance with external information. Consequently, priority of the memorandum can be changed in accordance with external factors and when priority is changed, the display mode and the display sequence can be changed, too. In other words, a memorandum terminal that is easier to use can be provided. The external factors include location information of the memorandum terminal, external conditions of the memorandum terminal such as an object relating to the content of the memorandum, and so forth.

The invention can accomplish a memorandum terminal that enables a plurality of users to share a memorandum as well as a completion state of the memorandum. In consequence, the invention can provide a memorandum terminal capable of assisting the execution of such a matter that can be completed by any one of a plurality of users.

Other objects, features and advantages of the invention will become apparent from the following description of the embodiments of the invention taken in conjunction with the accompanying drawings.

### BRIEF DESCRIPTION OF THE DRAWINGS

FIG. 1 shows a system having a plurality of memorandum terminals connected to a network;

FIG. 2 shows an internal block construction of the memorandum terminal;

FIG. 3 shows a data structure of a group list DB;

FIG. 4 shows a data structure of the memorandum list DB;

FIG. 5 shows a flowchart representing a sequence of new memorandum registration;

FIG. 6 shows an example of a display view 61;

FIG. 7 shows a flowchart representing a sequence of completion check;

FIG. 8 shows a data structure of a completion message;

FIG. 9 shows a flowchart representing a sequence of a priority change;

FIG. 10 shows a data structure of a priority change message; and

FIG. 11 shows a flowchart representing a priority judgment process.

### DESCRIPTION OF THE EMBODIMENT

Memorandum terminals according to the invention that can share a memorandum will be explained with reference to the accompanying drawings. Incidentally, the same reference numeral will be used to identify the same or equivalent portion and repetition of explanation will be omitted.

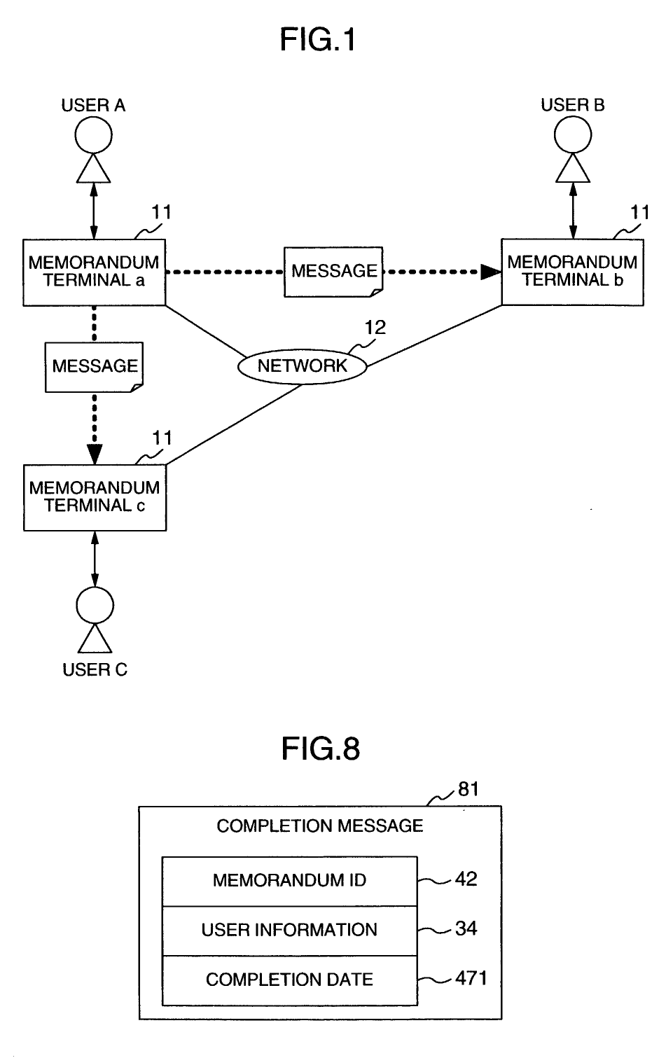

FIG. 1 shows a construction of a system including a plurality of memorandum terminals capable of sharing a memorandum and connected to a network. The memorandum terminals 11 individually used by a plurality of users are connected to the network 12 for mutual communication. When messages are exchanged among a plurality of memorandum terminals 11, the memorandum 41 can be shared. The memorandum terminal 11 is, for example, a mobile phone or a PDA, but is not limited to them so long as the terminals 11 can communicate information with one another. The network 12 is, for example, a wireless network of the mobile phones, but may well be communication means capable of mutual communication.

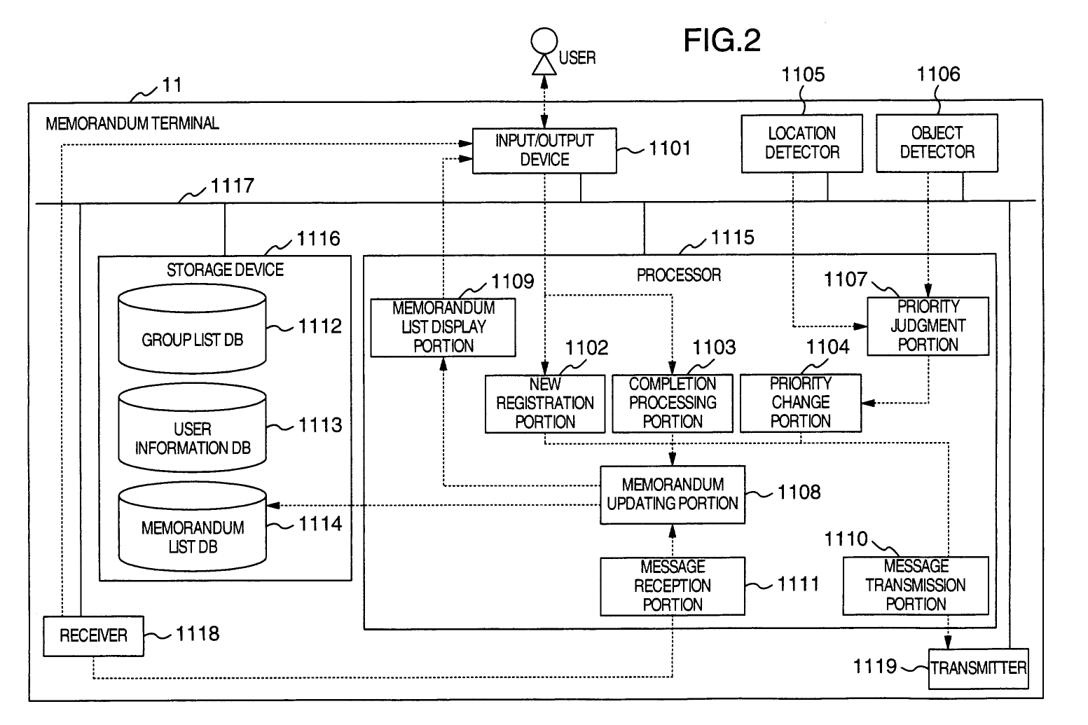

FIG. 2 is a block diagram that shows an internal construction of the memorandum terminal 11. The memorandum terminal 11 includes an input/output device 1101, a processor 1115, a storage device 1116, a transmitter 1119, a receiver 1118, a location detector 1105 and an object detector 1106 that are connected to one another through an internal bus 1117 so that they can exchange control signals, data, and so forth. A battery, not shown, is connected to each of these components and supplies electric power necessary for operation.

The input/output device 1101 is the one that displays information for a user and accepts a data input operation from the user. It is a liquid display device and a touch panel, for example, but means capable of executing the input and output operations from and to the user can be generally used. The input/output device 1101 may discretely have an input device and an output device, as well.

The location detector 1105 detects the location at which the memorandum terminal 11 now exists. The location detector 1105 utilizes a satellite or a base station of mobile phones, for example, but means for detecting the location may well be used.

The object detector 1106 detects an object 44 now existing in the proximity of the memorandum terminal 11. The object detector 1106 is a reception system of object information using near distance wireless communication, for example, but means capable of detecting the object 44 may well be used.

The receiver controls communication with an external network, receives data and hands it over to the processor 1115. The transmitter controls communication with the external network, receives data from the processor 1115 and transmits it to the external network. Though the drawing shows a construction discretely having the receiver 1118 and the transmitter 1119, a transmitter/receiver capable of transmission and reception may be used, too.

The storage device 1116 stores user information DB 1113 as database of the memorandum, group lists DB 1112 and DB 1114 and a memorandum program (not shown) for achieving the memorandum function.

The user information DB 1113 stores the name 35 of the user of the memorandum terminal 11 and the terminal ID 36 of the memorandum terminal 11. The set of the name 35 and the terminal ID 36 is called “user information 34”. The terminal ID 36 is an ID for specifying the terminal that executes communication. It is a phone number of a mobile phone, for example, but various ID may be used so long as they can primarily identify the memorandum terminals 11.

The group list DB 1112 stores a group of user information 34 of a plurality of users. It is a phone directory of mobile phones, for example, but various lists may be used so long as they can group and store a plurality of user information.

The memorandum list DB 1114 stores a plurality of memorandums 41. The user information DB 1113, the group list DB 1112 and the memorandum list DB 1114 are looked up by other components of the memorandum terminal 11.

The memorandum program is generally stored in a storage medium such as a CD-ROM and is transacted. It is inputted to the memorandum terminal 11 through a medium reader, not shown, and is stored in the storage device 1116. The memorandum program may also be transferred and transacted through the network. The memorandum program stored in the storage device 1116 is serially read out from the storage device to a work memory and is executed by the processor 1115 when the memorandum function is executed in accordance with the instruction from the input/output device 1101.

The memorandum program can be divided into the following functional blocks. A new registration portion 1102 generates and registers a new memorandum 41 and transmits a message to other memorandum terminals 11. A completion processing portion 1103 executes completion registration of a corresponding memorandum 41 and transmits a message to other memorandum terminals 11. A priority change portion 1104 changes priority 472 of the memorandum 41 and transmits a message to other memorandum terminals 11. A priority judgment portion 1107 judges and changes priority 472 of the memorandum 41 in response to the location of the memorandum terminal 11 or the object that is detected. A memorandum updating portion 1108 updates the memorandum 41 stored in the memorandum list DB 1114. A memorandum list display portion 1109 displays the list of the memorandums 41 stored in the memorandum list DB 1114. A message transmission portion 1110 transmits a message to other memorandum terminals 11. A message reception portion 1111 receives messages from other memorandum terminals 11.

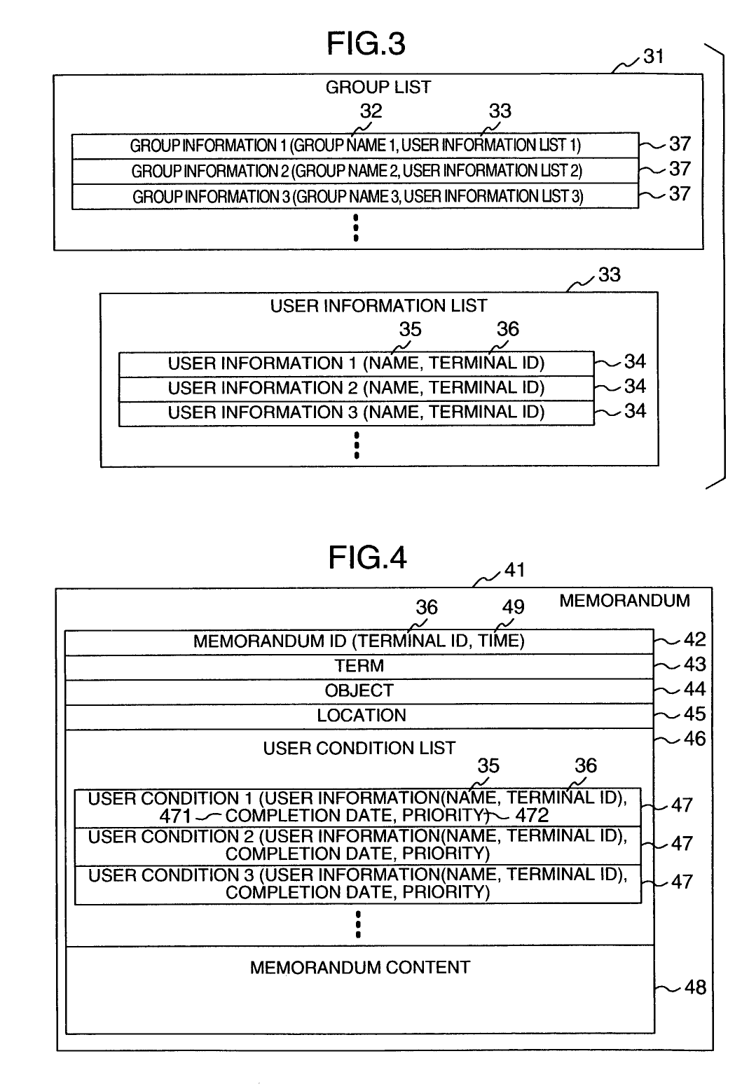

FIG. 3 shows a data structure of the group list 31 stored in the group list DB 1112. The group list 31 is an aggregate of group information including of a group name 32 as a name of a group and a user information list 33 of the users belonging to that group. The user information list 33 is an aggregate of user information 34. The group information 37 includes significant units such as a family and friends, and groups a plurality of user information 34.

FIG. 4 shows a data structure of the memorandum 41 stored in the memorandum list DB 1114. The memorandum list DB 1114 stores a plurality of memorandums 41. The memorandum ID 42 comprises a combination of the terminal ID 36 and a time 49 at which the memorandum 41 is worked out, and is an ID for primarily identifying the memorandum 41. However, the memorandum ID 42 is not particularly limited to this example so long as the ID can primarily identify the memorandum 41. A term 43 represents a completion date of execution of a content 48 of the memorandum described in the memorandum 41. The object 44 represents an object 44 when the memorandum 41 has a content associated with a certain matter. A location 45 represents a location 45 when the memorandum 41 is associated with a certain location 45. The term “location” 45 represents a location having significance such as a “shop” or a “post office” or latitude and longitude, but is not limited to these examples. A user condition list 46 represents an aggregate of conditions of the users. A user condition 47 includes user information of all the users sharing the memorandum 41, a completion date 471 of each user and priority 472. The completion date 471 represents the date on which execution of the matter described in the memorandum content 48 is completed and completion registration is made. When the execution is incomplete, the value is set to “incomplete”. Priority 472 represents a degree of importance of the content of the memorandum 41. When a plurality of memorandums 41 in the memorandum list DB 1114 is displayed, the memorandums 41 having higher priority 472 are placed and displayed at higher priority. The values of priority 472 are two kinds, that is, “high” and “medium”. In this embodiment, priority 472 is two stages but is not limited to the two stages. The memorandum content 48 is a document memorandum representing the matter that is not to be forgotten.

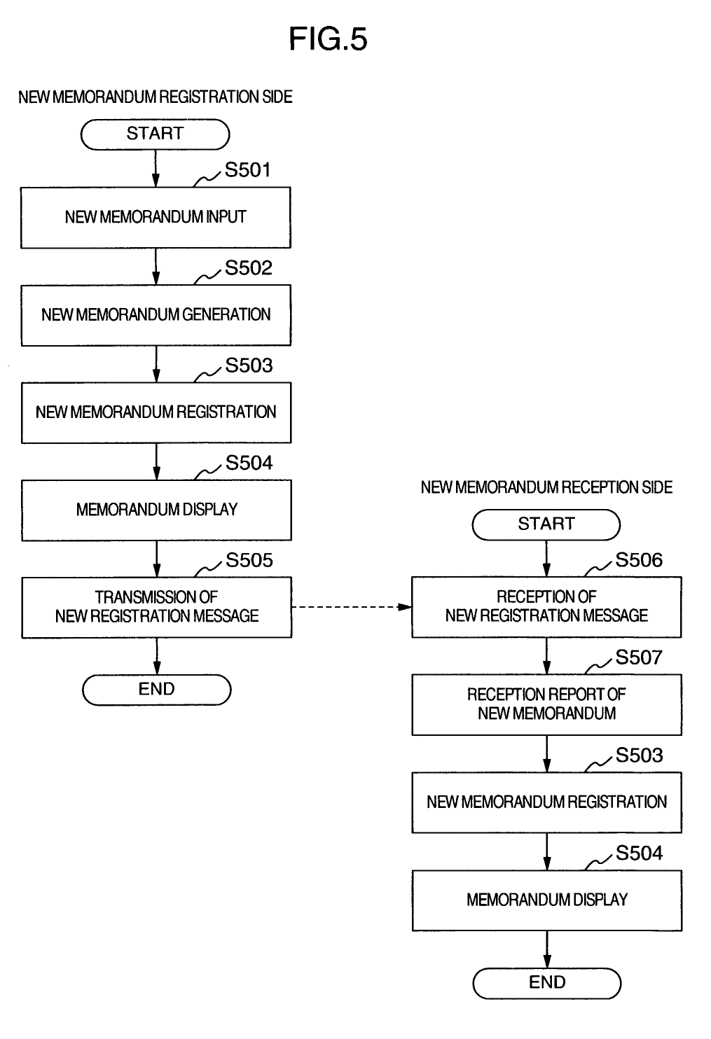

Next, the registration process sequence of the new memorandum 41 will be explained with reference to the flowchart of FIG. 5. The user inputs the term 43, the object 44, the location 45, the group name 32 and the memorandum content 48 as the information for generating the memorandum 41 to be afresh registered through the input/output device 1101 (Step S501). When the associated object 44 or location 45 does not exist in the memorandum 41, these items need not be inputted. The group name 32 is the name of the group that is to share the memorandum 41. The group name 32 is inputted when the input/output portion 1101 displays wholly or partially the group name 32 stored in the group list DB 1112, and the user selects one of them.

Receiving the input data from the input/output device 1101, the new registration portion 1102 generates data of the new memorandum 41 on the basis of the input data (Step S502). In this instance, the terminal ID 36 stored in the user information DB 1113 is acquired and is put together with the present time 40 to provide the memorandum ID 42.

Also, each user information 34 inside the user information list 33 corresponding to the group name 32 the user selects is taken out, and the completion date 471 and priority 472 are added to this user information 34 to generate the user condition 47. Next, the completion date 471 and priority 472 are also added to the user information 34 of the user itself stored in the user information DB 1113 to generate the user condition 47 of the user itself. The values of these completion date 471 and priority 472 are set to “incomplete” and “medium”, respectively. All the user conditions 47 so generated are put together to give the user condition list 46. At this time, the user condition 47 of the user itself is arranged at the highest order of the list. Consequently, the user generating this memorandum 41 can be specified. The term 43, the object 44, the location 45 and the memorandum content 48 are the information the user inputs in Step S501.

When the memorandum 41 is generated, the memorandum updating portion 1108 stores the data of the memorandum 41 so generated in the memorandum list DB 1114 (Step S503). The memorandum list display portion 1109 displays the list of the memorandums 41 inside the updated memorandum list DB 1114 through the input/output portion 1101 (Step S504).

The new registration portion 1102 transmits data of the memorandum 41 thus generated as the new registration message to the terminal ID 36 of the user condition 47 with the exception of the user itself, that is, the memorandum terminals 41 of the group other than the memorandum terminal of its own, among the user conditions 47 in the user condition list 46 in the data of the memorandums 41 generated in Step S502 (Step S505).

Next, the processing sequence on the message reception side will be explained. The message reception portion 1111 of the memorandum terminal 41 on the message reception side receives the new registration message (Step S506) and then notifies the users of the reception of the new registration message through the input/output device 1101 (Step S507). The message reception portion 1111 further stores the new registration message it receives as the new memorandum 41 in the memorandum list DB 1114 through the memorandum update portion 1108 (Step S503). The memorandum list display portion 1109 displays the list of the memorandums 41 inside the updated memorandum list DB 1114 through the input/output portion (Step S504).

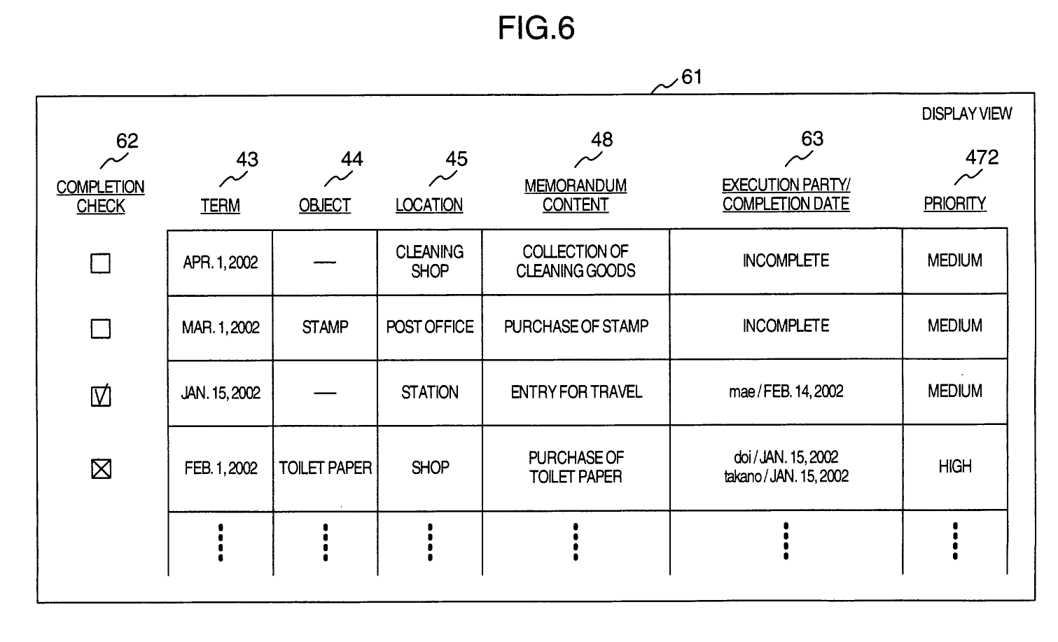

The display sequence of the memorandum list in Step S504 will be explained with reference to FIG. 6 that shows an example of a display screen of the list of the memorandums 41. When the completion date 471 of any user condition 47 in the user condition list 46 inside the memorandum 41 has already been set among all the memorandums 41 stored in the memorandum list DB 1114, this memorandum has been already registered as “complete”. When the value of the completion date 471 of all the user conditions is “incomplete”, the memorandum 41 is not yet completed. The incomplete memorandum 41 among all the memorandums 41 is displayed in the following sequence. All the memorandums 41 in which priority 472 of the user condition 47 of itself is “high” are displayed at higher order positions in the order closer to the term 43. Next, all the memorandums 41 in which priority 472 of all the user conditions 47 is “medium” are displayed at higher position in the order closer to the term 43. Further, all the memorandums 41 in which priority 472 of the user condition 47 of the user itself is “medium” and in which “high” exists in priority 472 of the user conditions 47 of other users are displayed at higher positions in the order closer to the term 43. Next, the remaining memorandums 41 that have been registered as “completed” are displayed in the order closer to the term 43. Incidentally, the explanation is given in this embodiment about the example where the display sequence of the memorandums having higher priority is changed. However, the display mode may also be changed by changing background colors or emphasizing character display in accordance with the degree of priority that is changed in accordance with the situation of the memorandum terminals such as the information from other memorandum terminals, the location of the memorandum terminals, the object detected, and so forth.

The display sequence of each display item in FIG. 6 will be explained. When the completion date 471 of the user condition 47 of its own is not “incomplete”, a check mark is displayed as a display of completion. When the completion date 471 of the user condition 47 other than its own is not “incomplete”, a display representing that the check is not possible is displayed as the completion display. A display representing that the check is possible is displayed in other cases. A completion check 62 is an input portion through which the user executes completion registration after the matter of the memorandum content 48 of the memorandum 41 is completed. An execution party/execution date 63 displays the name 35 and the completion date 471 of all the user conditions 47 in the user condition list 46 to which the completion date 471 is set. The execution party/execution date 63 is a display for confirming whether or not the memorandum 41 has been completed, who has completed the memorandum 41 and whether or not the memorandum 41 is executed in overlap. The term 43, the object 44, the location 45, the memorandum content 48 and priority 472 display the content of the memorandum 42 as such. The party who works out the memorandum and other data contained in the memorandum may also be displayed besides the items described above.

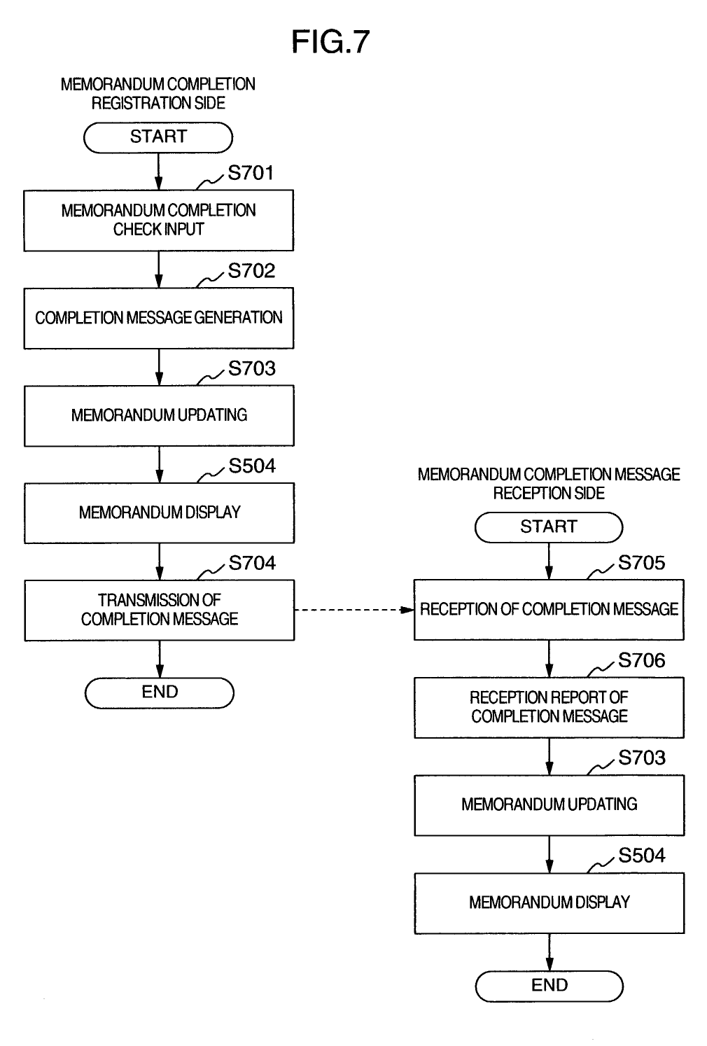

Next, the registration sequence of completion of the memorandum in this embodiment will be explained with reference to the flowchart of FIG. 7. The user conducts the completion check 62 of the memorandum 41 for which the user desires to make completion registration among the memorandums 41 displayed on the screen through the input/output portion 1101 (Step S701). A completion processing portion 1103 generates a completion message 81 of the memorandum 41 so checked (Step S702). FIG. 8 shows a structure of the completion message 81. The completion message 81 comprises a combination of the memorandum ID 42 of the memorandum 41 checked in Step S701, the user information 34 stored in the user information DB 1113 and the completion date 471 that uses the present date as its value.

The memorandum updating portion 1108 changes the completion date 471 of the user condition 47 of the corresponding memorandum 41 to the value of the completion date 471 of the completion message 81 on the basis of this completion message 81, and updates the memorandum list DB 1114 (Step S703). The memorandum list display portion 1109 displays the list of the memorandums 41 inside the memorandum list DB 1114 updated (Step S504). The completion processing portion 1103 transmits the completion message 81 so generated to the terminals ID 36 of all the user information 47 other than that of its own among the user information 47 in the user condition list 46 of the memorandums 41 for which completion registration is made, that is, to the memorandum terminals 41 other than of its own.

Next, the process on the message reception side will be explained. The message reception portion 1111 of the memorandum terminal 41 on the message reception side receives the completion message 81 (Step S705) and notifies the users of the reception of the completion message 8 through the input/output portion (Step S706). The message reception portion 1111 takes out the memorandum ID 42 of the completion message 81, the user information 34 and the completion date 471, changes the completion date 471 of the corresponding user condition 47 of the corresponding memorandum 41 to the completion date 471 thus taken out through the memorandum updating portion 1108, and updates the memorandum list DB 1114 (Step S703). The memorandum list display portion 1109 displays the list of the memorandum 41 (Step S504).

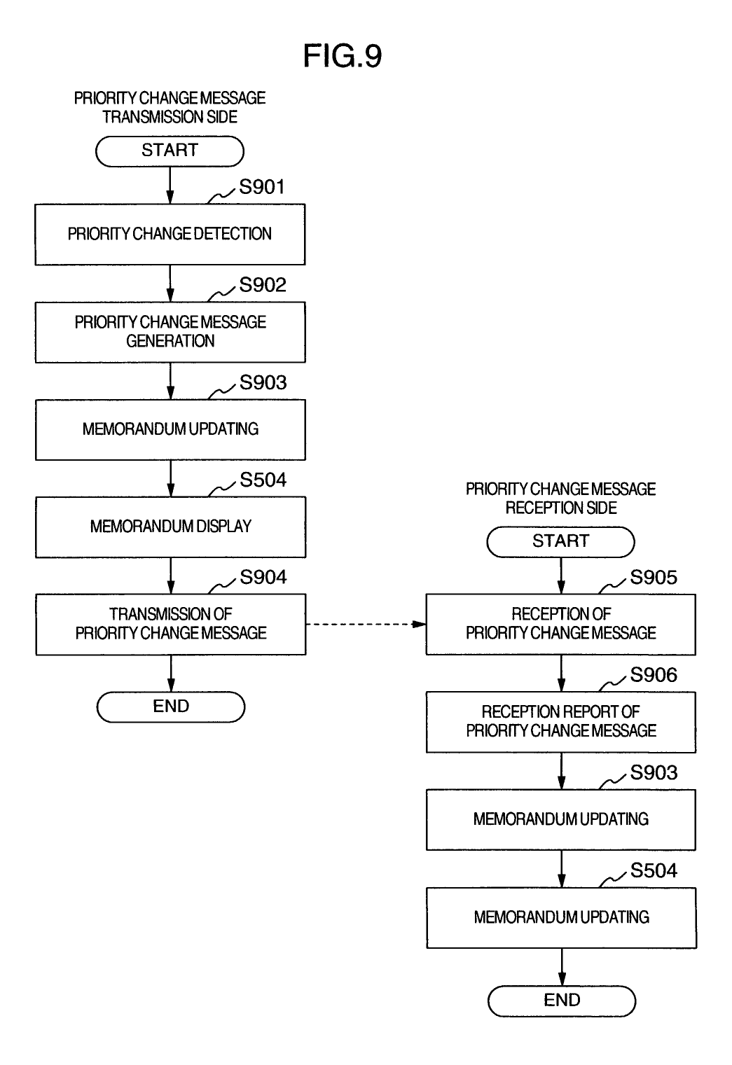

Next, the change process of priority 472 of the memorandum in this embodiment will be explained with reference to the flowchart shown in FIG. 9. The priority judgment portion 1107 judges the existence/ absence of the change of priority 472 of the memorandum 41 on the basis of the information on the location 45 from the location detection portion 1105 or the information on the object 44 from the object detection portion 1106 (Step S901), and creates the priority change message 101 when the change of priority 472 is necessary (Step S902).

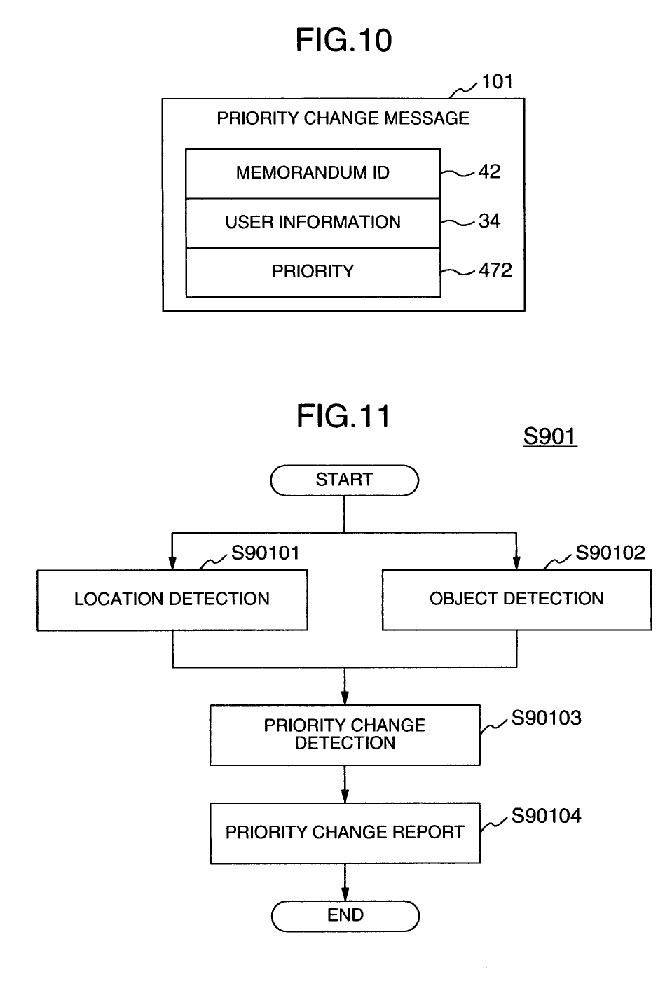

FIG. 10 shows the structure of the priority change message 101. The priority change message 101 includes the memorandum ID 42 of the memorandum 41 priority 472 of which is judged as to be changed in Step S901, the user information 34 and priority 473 after the change that are judged as existing in Step S901.

The memorandum updating portion 1108 changes priority 472 of the user condition 47 of the corresponding memorandum 41 of its own to the value of priority 472 of the priority change message 101 on the basis of the priority change message 101 and updates the memorandum list DB 1114 (Step S903). The memorandum list display portion 1109 displays the list of the memorandums 41 (Step S504).

The priority change portion 1104 transmits the priority change message 101 so created to the terminal ID 36 of all the user information 47 other than the terminal of its own, that is, the memorandum terminals 41 other than the terminal of the group of its own, through the message transmission portion 1110.

Next, the process sequence on the message reception side will be explained. The message reception portion 1111 of the memorandum terminal 41 on the message reception side receives the priority change message 101 (Step S905) and notifies the users of the reception of the priority change message 101 (Step S906). The message reception portion 1111 takes out the memorandum ID 42 of the priority change message 101, the user information 34 and priority 472, changes priority 472 of the corresponding user condition 47 of the corresponding memorandum 41 to priority 472 thus taken out through the memorandum updating portion 1108, and updates the memorandum list DB 1114 (Step S903). The memorandum list display portion 1109 displays the list of the memorandums 41 (Step S504).

The process sequence of Step S901 will be explained next with reference to the flowchart of FIG. 11 that represents the sequence of the priority judgment process. The location detection portion 1105 detects the location 45 of the memorandum terminal 11 and transmits the location after the change to the priority judgment portion 1107 if any change of the location 45 exists (Step S90101). The object detection portion 1106 detects the content of the object 44 existing around the memorandum terminal 11 and transmits the object after the change to the priority judgment portion 1107 if any change of the object 44 exists (Step S90102).

The priority judgment portion 1107 retrieves all the memorandums 41 having the location 45 or the object 44 detected in Step S90101 or S90102 from the list of the memorandums 41 stored in the memorandum list DB 1114 and gives the instruction to the priority change portion 1104 to change priority of all the memorandums 41 having the priority value “medium” to “high” (Steps S90103 and S90104). When the latitude and longitude is used as the location 45 in Step S90103, the memorandum 41 is judged as the one whose priority must be changed to “high” if the difference between the location 45 in the memorandum 44 and the location 45 detected by the location detection portion 1105 remains within a predetermined value. Next, all the memorandums 41 the location 45 and the object 44 of which are not coincident are retrieved from the list 41 stored in the memorandum list DB 1114, and the priority judgment portion 1107 gives the instruction to the priority change portion 1104 to change priority 472 of all the corresponding memorandums 41 having the priority value “high” to the priority value “medium” (Steps S90103 and S90104).

In the change judgment of priority 472 of the priority judgment portion 1107, this embodiment simply uses the location 45 of the memorandum terminal 11 and the surrounding object 45 as the factors of the change. However, it is also possible to conduct the change judgment of priority 472 by receiving sale information of goods, for example, and detecting the associated memorandums 41 in the priority judgment portion 1107. It is further possible to automatically detect the user condition, or to accept the input of the user condition by the user itself, to judge priority 472 of each memorandum 41 by the priority judgment portion 1107 and to change priority 472. The term “user condition” means the behavior conditions of the user such as working, moving, rest, meeting, and so forth. In this embodiment, the priority judgment portion 1107 automatically changes priority 472, but the user may directly input the instruction to change priority 472.

The memorandum terminal in the embodiment described above can transmit the memorandum 41 registered afresh to the memorandum terminals 11 used by a plurality of other users and can register it as the new memorandum 41 to the memorandum terminal 11 as the destination of transmission. Therefore, a plurality of users can share the memorandum 41. The completed message after completion registration can be transmitted to all the memorandum terminals 11 of the users sharing the memorandum 41, and completion registration can be made to the transmitted memorandum terminal 11, so that a plurality of users can share the completion state of the memorandum. Furthermore, priority 472 can be changed in association with not only the fixed factors such as the term but also external factors such as the location and the surrounding condition. The change of priority 472 is transmitted to all the memorandum terminals of the users sharing the memorandum 41 and can be used as the factor for judging the display sequence when the list of the memorandum 41 is displayed at the transmitted memorandum terminals 11. In other words, the display sequence of the memorandum can be changed in accordance with the conditions of other users. When the memorandum terminal 11 is achieved in the mobile information terminal having a limited display area, the display chance of the memorandum 41 having a higher degree of importance can be increased, and a memorandum 41 having a higher degree of importance becomes more noticeable and does not need an operation such as scrolling.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A memorandum terminal including:
a memorandum data storage portion for storing a memorandum DB;
an input device for inputting said memorandum data;
an output device for displaying said memorandum data;
a processing portion for processing said memorandum data; and
a transmitter/receiver for exchanging said memorandum data with other memorandum terminals;
wherein said processing portion transmits new memorandum data to other memorandum terminals through said transmitter/receiver and executes an updating process of said memorandum DB on a basis of said memorandum data received from other memorandum terminals through said transmitter/receiver.

2. A memorandum terminal as defined in claim 1, wherein said memorandum DB includes a group list DB storing other memorandum terminals sharing said memorandum data, and said processing portion transmits said new memorandum data to other memorandum terminals registered as a group to which said new memorandum data belongs.

3. A memorandum terminal as defined in claim 2, wherein said new memorandum data contains data of execution completion of said memorandum data already registered to said memorandum DB.

4. A memorandum terminal as defined in claim 2, wherein said new memorandum data contains priority data of said memorandum.

5. A memorandum terminal as defined in claim 2, wherein said processing portion displays said memorandum data inside said memorandum DB on said output device, and changes a display mode of said memorandum data in accordance with said new memorandum data said transmitter/receiver receives.

6. A memorandum terminal as defined in claim 2, which further includes a location detector for detecting a location of said memorandum terminal, and wherein said processing portion changes a display mode of said memorandum data displayed on said output device in accordance with the location detected.

7. A memorandum terminal as defined in claim 5, wherein said display mode is a display sequence of said memorandum data.

8. A memorandum terminal as defined in claim 6, wherein said display mode is a display sequence of said memorandum data.

9. A memorandum terminal as defined in claim 2, which further includes an object detector for detecting a surrounding condition of said memorandum terminal, and wherein said processing portion changes a display mode of said memorandum data displayed on said output device in accordance with the surrounding condition detected.

10. A memorandum terminal as defined in claim 9, wherein said display mode is a display sequence of said memorandum data.

11. A memorandum terminal including:
a memorandum data storage portion for storing a memorandum DB;
an input device for inputting said memorandum data;
an output device for displaying said memorandum data;
a processing portion for processing said memorandum data; and
a location detector for detecting a location of said memorandum terminal;
wherein said processing portion changes a display mode of said memorandum data displayed on said output device in accordance with the location detected.

12. A memorandum terminal as defined in claim 11, wherein said display mode is a display sequence of said memorandum data.

13. A memorandum terminal including:
a memorandum data storage portion for storing a memorandum DB;
an input device for inputting said memorandum data;
an output device for displaying said memorandum data;
a processing portion for processing said memorandum data; and
an object detector for detecting a surrounding condition of said memorandum terminal;
wherein said processing portion changes a display mode of said memorandum data displayed on said output device in accordance with a surrounding condition detected.

14. A memorandum terminal as defined in claim 11, wherein said display mode is a display sequence of said memorandum data.

15. A method of managing memorandum by use of a memorandum terminal including a memorandum data storage portion for storing a memorandum DB, an input device for inputting said memorandum data, an output device for displaying said memorandum data, a processing portion for processing said memorandum data, and a transmitter/receiver for exchanging said memorandum data with other memorandum terminals; said method comprising the steps of:
updating said memorandum DB on the basis of new memorandum data inputted from said input device;
transmitting said new memorandum data to other memorandum terminals through said transmitter/receiver; and
updating said memorandum DB on the basis of said memorandum data received on a side of said other memorandum terminals receiving said memorandum data.

16. A method of managing a memorandum as defined in claim 15, wherein said process for transmitting said new memorandum data includes a step of deciding a destination terminal on a basis of a group list DB storing other memorandum terminals sharing said memorandum DB to which said new memorandum data belongs.

17. A method of managing a memorandum as defined in claim 15, wherein a display mode of said memorandum data is changed in accordance with said new memorandum data said transmitter/receiver receives.

18. A memorandum terminal as defined in claim 17, wherein said display mode is a display sequence of said memorandum data.
